(19) United States
(12) Patent Application Publication
(10) Pub. No.: US 2007/0030219 A1
(43) Pub. Date: Feb. 8, 2007

(54) Display device and driving method thereof

(76) Inventors: Kyong-Tae Park, Suwon-si (KR); Si-Duk Sung, Seoul (KR); Nam-Deog Kim, Yongin-si (KR)

Correspondence Address: CANTOR COLBURN, LLP, 55 GRIFFIN ROAD SOUTH, BLOOMFIELD, CT, 06002, US

(21) Appl. No.: 11/415,493

(22) Filed: Apr. 28, 2006

(30) Foreign Application Priority Data
Apr. 5, 2005 (KR) 10-2005-0037604

(51) Int. Cl. G09G 3/30

(52) U.S. Cl. 345/76

(57) ABSTRACT

A display device and a method of driving the display device include first and second pixel row groups having at least one pixel row including a plurality of pixels, a plurality of scan lines, a plurality of data lines, and a data driver generating the data voltage including a normal data voltage and a reverse bias voltage. The data driver applies one of the normal data voltage and the reverse bias voltage to the data line according to a selection signal. The normal data voltage is applied to the driving transistors of the first pixel row group, and the reverse bias voltage is applied to the driving transistors of the second pixel row group. Accordingly, the reverse bias voltages are applied to the pixels, preventing transition of threshold voltages of the driving transistors.

This application claims priority to Korean Patent Application No. 10-2005-0037604, filed on May 4, 2005, and all the benefits accruing therefrom under 35 U.S.C. §119, and the contents of which in its entirety are herein incorporated by reference.

### BACKGROUND OF THE INVENTION

(a) Field of the Invention

The present invention relates to a display device and a driving method thereof, and more particularly, to an organic light emitting display device and a driving method thereof.

(b) Description of the Related Art

Recently, as thin and lightweight types of personal computers and television sets have been required, cathode ray tubes (“CRTs”) have been replaced with flat display devices.

Flat display devices include liquid crystal display (“LCD”) devices, field emission display (“FED”) devices, organic light emitting display (“OLED”) devices, plasma display panel (“PDP”) devices, and the like.

The organic light emitting display device includes organic light emitting diodes (“OLEDs”) and thin film transistors (“TFTs”), which drive the organic light emitting diodes. The thin film transistors are classified into polysilicon thin film transistors and amorphous silicon thin film transistors according to types of active layers. The organic light emitting display devices employing the polysilicon thin film transistors have been generally used due to several advantages provided by the polysilicon thin film transistors. However, manufacturing processes for the polysilicon thin film transistors are complex, thus increasing production costs thereof. In addition, it is difficult to obtain a wide screen by using the organic light emitting display devices.

A wide screen can be easily obtained, however, by using the organic light emitting display device employing the amorphous silicon thin film transistors. In addition, the number of production processes thereof is relatively smaller than that of the organic light emitting display device employing the polysilicon thin film transistors. However, as the amorphous silicon thin film transistors continuously supply a current to the organic light emitting diodes, the threshold voltage of the amorphous silicon thin film transistors may deteriorate. Even though the same data voltage is applied, non-uniform current flows through the organic light emitting diodes, thus deteriorating the image quality and possibly shortening the life cycle of the organic light emitting display device.

Therefore, various pixel circuits for compensating for a transition of the threshold voltage have been proposed in order to prevent deterioration in image quality. However, the aperture ratios of pixels are lowered because these pixel circuits include a large number of thin film transistors, capacitors and wire lines.

### BRIEF SUMMARY OF THE INVENTION

The present invention provides a display device with a simplified pixel circuit that is capable of increasing aspect ratios of pixels and preventing transition of a threshold voltage of ah amorphous silicon thin film transistor to suppress deterioration in image quality, and a method of driving the display device.

According to an exemplary embodiment of the present invention, a display device includes: a first pixel row group and a second pixel row group, each group including at least one pixel row having a plurality of pixels, each pixel having a switching transistor, a capacitor, a driving transistor connected to the switching transistor, and a light emitting element connected to the driving transistor; a plurality of scan signal lines connected to the switching transistors to transmit scan signals; a plurality of data lines connected to the switching transistors to transmit data voltages, the data voltages including a normal data voltage and a reverse bias voltage; and a data driver generating the data voltage. The data driver applies one of the normal data voltage and the reverse bias voltage to the data line according to a selection signal, wherein the normal data voltage is applied to the driving transistors of the first pixel row group, and the reverse bias voltage is applied to the driving transistors of the second pixel row group.

In the above exemplary embodiment of the present invention, the first pixel row group and the second pixel row group may each includes a plurality of pixel rows, wherein the normal data voltage is sequentially applied to the driving transistors of the first pixel row groups row-by-row, and wherein the reverse bias voltage is simultaneously applied to the driving transistors of a plurality of the pixel rows of the second pixel row group.

One frame may be divided into a first interval and a second interval, wherein, when the normal data voltage is applied to the driving transistors of the first pixel row group in the first interval, the reverse bias voltage is applied in the second interval, and wherein, when the reverse bias voltage is applied to the driving transistors of the second pixel row group in the first interval, the normal data voltage is applied in the second interval.

After the normal data voltage is applied to the driving transistors of the first pixel row group, the reverse bias voltage may be applied, and after the reverse bias voltage is applied to the driving transistors of the second pixel row group, the normal data voltage may be applied.

The first pixel row group and the second pixel row group may be alternately arrayed, and the normal data voltage and the reverse bias voltage may be alternately applied to the driving transistors row-by-row.

The display device may further include a third pixel row group and a fourth pixel row group including at least one pixel row, wherein the normal data voltage is applied to the driving transistors of the third pixel row group, and wherein the reverse bias voltage is applied to the driving transistors of the fourth pixel row group.

The first pixel row group, the second pixel row group, the third pixel row group and the fourth pixel row group may be sequentially arrayed, and the reverse bias voltage may be simultaneously applied to the second pixel row group and fourth pixel row group. The normal data voltage may be sequentially applied to the driving transistors of the first pixel row group and the third pixel row group. In addition, the normal data voltage may be sequentially applied to the driving transistors of a plurality of the pixel rows, and the reverse bias voltage is simultaneously applied to the driving transistors of a plurality of the pixel rows.

The selection signal may have high and low levels, and the data driver may output one of the normal data voltage and the reverse bias voltage according to the level of the selection signal. A period of the selection signal may be a multiple of one horizontal period.

In one frame, a length of the interval where the data driver outputs the normal data voltage may be equal to or larger than a length of the interval where the data driver outputs the reverse bias voltage. In addition, in one period of the selection signal, a length of the level of the selection signal where the data driver outputs the normal data voltage may be equal to or larger than a length of the level of the selection signal where the data driver outputs the reverse bias voltage.

The polarity of the reverse bias voltage may be opposite to that of the normal data voltage, and the reverse bias voltage may be a negative voltage. A size of the reverse bias voltage may be proportional to that of the normal data voltage, or it may have a predetermined value.

According to another exemplary embodiment of the present invention, a display device includes: a display panel that is divided into a plurality of blocks; a plurality of scan signal lines disposed on the display panel to transmit scan signals; a plurality of data lines intersecting the scan signal lines to transmit data voltages; a plurality of pixels, each of which has a switching transistor connected to the scan signal line and the data line, a capacitor, a driving transistor connected to the switching transistor, and a light emitting element connected to the driving transistor; and a data driver generating the data voltage including a normal data voltage and a reverse bias voltage. The data driver applies one of the normal data voltage and the reverse bias voltage to the data line according to a selection signal, wherein, when the reverse bias voltage is applied to the data line, the scan signals are simultaneously applied to at least two scan signal lines.

The display device may further include a scan driver that applies scan signals to the scan signal lines to turn on the switching transistor of each pixel at least two times in one frame.

The plurality of blocks may include first and second blocks, wherein the scan signals are sequentially applied to the scan signal lines of the first block, and wherein the scan signals are simultaneously applied to at least two scan signal lines of the second block. The normal data voltages may be applied to the driving transistors of the first block, and the reverse bias voltages may be applied to the driving transistors of the second block.

In addition, the plurality of blocks may include first to fourth blocks that are sequentially arrayed, wherein the scan signals are sequentially applied to the scan signal lines of the first and third blocks, and wherein the scan signals are simultaneously applied to at least one scan signal line of the second block and at least one scan signal line of the fourth block. Further, the normal data voltages may be applied to the driving transistors of the first and third blocks, and the reverse bias voltages may be applied to the driving transistors of the second and fourth blocks.

According to still another exemplary embodiment of the present invention, a method of driving a display device having a display panel that is divided into a plurality of blocks, a plurality of scan signal lines disposed on the display panel to transmit scan signals, a plurality of data lines transmitting data voltages including a normal data voltage and a reverse bias voltage, and a plurality of pixels, each of which has a switching transistor connected to the scan signal line and the data line, a driving transistor connected to the switching transistor, and a light emitting element connected to the driving transistor, the method includes: applying the normal data voltages to the data lines; applying the scan signals to the scan signal lines at the same time of or after applying the normal data voltages; applying the reverse bias voltages to the data lines; and simultaneously applying the scan signals to at least two of the scan signal lines at the same time of or after applying the reverse bias voltages.

In the above exemplary embodiment of the present invention, the plurality of blocks may include first and second blocks, wherein the applying the scan signals includes applying the scan signals to the scan signal lines of the first block, and wherein simultaneously applying the scan signals includes simultaneously applying the scan signals to at least two of the scan signal lines of the second block.

In addition, the plurality of blocks may include first to fourth blocks which are sequentially arrayed, wherein the applying the scan signals includes sequentially applying the scan signals to the scan signal lines of the first block and the scan signal lines of the third block, and wherein the simultaneously applying the scan signals includes simultaneously applying the scan signals to the scan signal lines of the second block and the scan signal lines of the fourth block.

The method may further include: dividing one frame into a first interval and a second interval; applying the reverse bias voltages in the second interval when the normal data voltages are applied to the driving transistors in the first interval; and applying the normal data voltages in the second interval when the reverse bias voltages are applied to the driving transistors in the first interval.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram showing an exemplary embodiment of an organic light emitting display device according to the present invention;

FIG. 2 is an equivalent circuit schematic diagram showing an exemplary embodiment of a pixel of the organic light emitting display device according to the present invention;

FIG. 3 is a cross-sectional view showing an example of a cross section of a driving transistor and an organic light emitting diode of the pixel of the organic light emitting display device shown in FIG. 2;

FIG. 4 is a schematic view showing an exemplary embodiment of an organic light emitting diode of the organic light emitting display device according to the present invention;

FIG. 5 is a block diagram showing an example of a data driver of the organic light emitting display device shown in FIG. 1;

FIG. 6 is a timing diagram showing an example of input and output signals of the data driver shown in FIG. 5;

FIGS. 7A and 7B are waveform views showing an example of a data voltage applied by the data driver shown in FIG. 5;

FIG. 8 is a timing diagram showing an example of an exemplary embodiment of a driving signal of the organic light emitting display device according to the present invention;

FIG. 9 is a schematic view showing a screen of the organic light emitting display device on which an image is displayed according to the driving signal shown in FIG. 8;

FIG. 10 is a block diagram showing another exemplary embodiment of an organic light emitting display device according to the present invention;

FIG. 11 is a timing diagram showing an example of another exemplary embodiment of a driving signal of the organic light emitting display device according to the present invention;

FIG. 12 is a schematic view showing a screen of the organic light emitting display device on which an image is displayed according to the driving signal shown in FIG. 11;

FIG. 13 is a timing diagram showing an example of another exemplary embodiment of a driving signal of the organic light emitting display device according to the present invention;

FIG. 14 is a block diagram showing another exemplary embodiment of an organic light emitting display device according to the present invention;

FIG. 15 is a timing diagram showing an example of another exemplary embodiment of a driving signal of the organic light emitting display device according to the present invention; and

FIG. 16 is a schematic view showing a screen of the organic light emitting display device on which an image is displayed according to the driving signal shown in FIG. 15.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Now, exemplary embodiments of a display device and a driving method therefore according to the present invention will be described in detail with reference to the accompanying drawings.

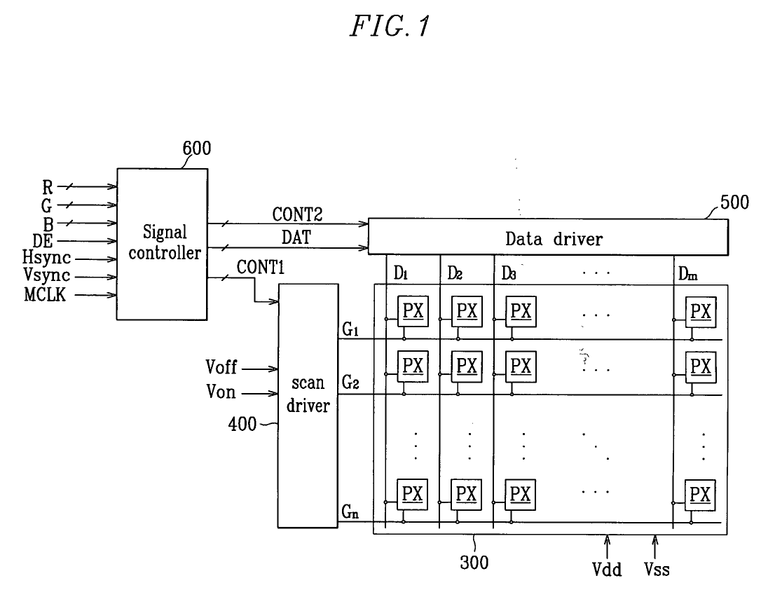

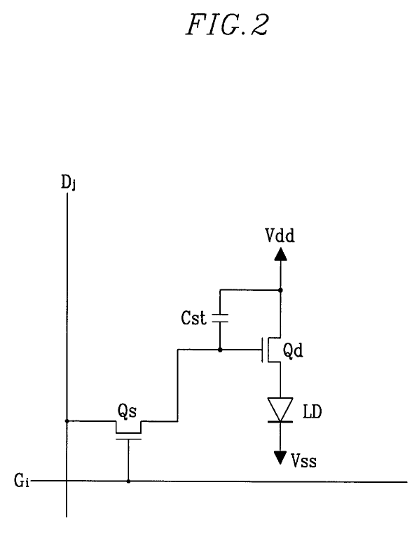

FIG. 1 is a block diagram showing an exemplary embodiment of an organic light emitting display device according to the present invention. FIG. 2 is an equivalent circuit schematic diagram showing an exemplary embodiment of a pixel of the organic light emitting display device according to the present invention.

As shown in FIG. 1, the exemplary embodiment of organic light emitting display device according to the present invention includes a display panel 300, scan and data drivers 400 and 500, respectively, that are connected to the display panel 300, and a signal controller 600 that controls the drivers 400 and 500.

As seen in the equivalent circuit schematic diagram, the display panel 300 includes a plurality of display signal lines G₁ to Gₙ and D₁ to Dₘ, a plurality of driving voltages lines (not shown), and a plurality of pixels PX that are connected to the lines and arrayed substantially in a matrix.

The display signal lines G₁ to Gₙ and D₁ to Dₘ include a plurality of scan signal lines G₁ to Gₙ that transmit scan signals Vg₁ to Vgₙ and a plurality of data lines D₁ to Dₘ that transmit data signals. The scan signal lines G₁ to Gₙ extend substantially in the row direction and are separated from and substantially parallel to each other. The data lines D₁ to Dₘ extend substantially in the column direction and are also separated from and substantially parallel to each other.

The driving voltage lines transmit driving voltages Vdd to the pixels PX. As shown in FIG. 2, each of the pixels PX, for example a pixel connected to the scan signal line Gᵢ and the data line Dⱼ, includes an organic light emitting diode LD, a driving transistor Qd, a capacitor Cst and a switching transistor Qs.

The driving transistor Qd is a three-port device having control, input and output ports. The control port is connected to the switching transistor Qs and the capacitor Cst, the input port is connected to the driving voltage Vdd, and the output port is connected to the organic light emitting diode LD.

The switching transistor Qs is also a three-port device having control, input and output ports. The control and input ports are connected to the scan signal line Gᵢ and the data line Dᵢ, respectively. The output port is connected to the capacitor Cst and the driving transistor Qd.

The capacitor Cst is connected between the switching transistor Qs and the driving voltage Vdd. The capacitor Cst sustains the data voltage Vdd charged by the switching transistor Qs for a predetermined time period.

An anode and a cathode of the organic light emitting diode LD are connected to the driving transistor Qd and a common voltage Vss, respectively. The organic light emitting diode LD emits light with different intensities according to an amount of a current I_{LD} supplied by the driving transistor Qd, so that an image can be displayed. The amount of the current I_{LD} greatly depends on a magnitude of a voltage Vgs between the control and output ports of the driving transistor Qd.

The switching and driving transistors Qs and Qd are n-channel field effect transistors (“FETs”) made of an amorphous silicon or polysilicon. Alternatively, the transistors Qs and Qd may be p-channel field effect transistors. In this case, since the p-channel and n-channel field effect transistors are complementary to each other, the operation, voltage and current of the p-channel field effect transistor are opposite to those of the n-channel field effect transistor.

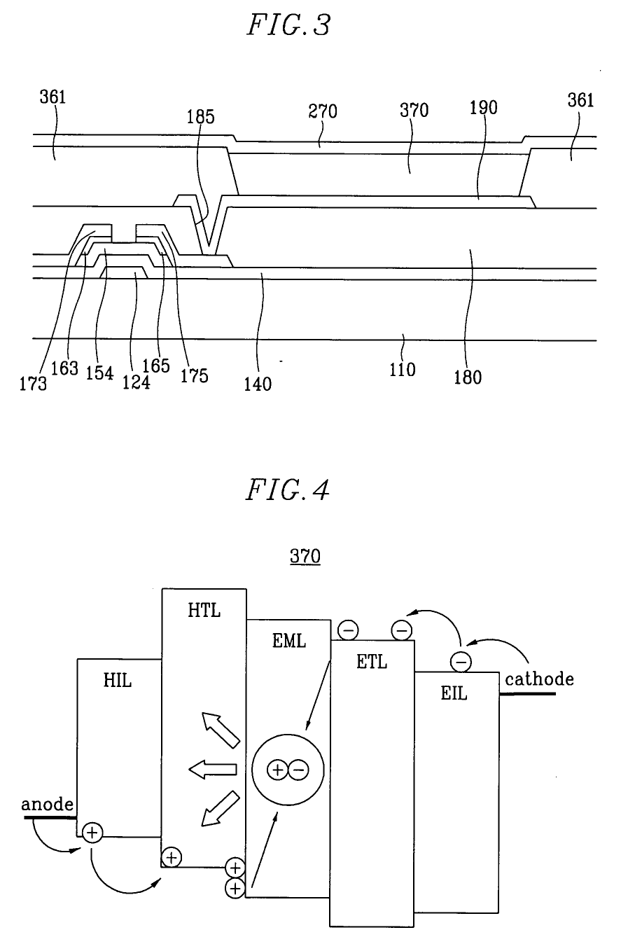

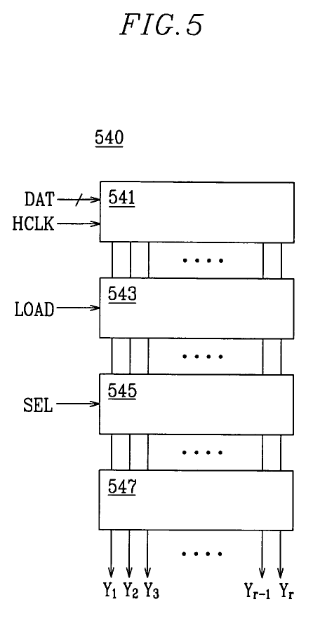

Now, structures of the driving transistor Qd and the organic light emitting diode LD of the organic light emitting display device shown in FIG. 2 will be described in detail with reference to FIGS. 3 and 4.

FIG. 3 is a cross-sectional view showing an example of a cross section of a driving transistor and an organic light emitting diode of a pixel of the organic light emitting display device shown in FIG. 2. FIG. 4 is a schematic view showing an exemplary embodiment of an organic light emitting diode of the organic light emitting display device according to the present invention.

A control electrode 124 is formed on a dielectric substrate 110. In one embodiment, the control electrode 124 is made of an aluminum-based metal such as aluminum (Al) and an aluminum alloy, a silver-based metal such as silver (Ag) and a silver alloy, a copper-based metal such as copper (Cu) and a copper alloy, a molybdenum-based metal such as molybdenum (Mo) and a molybdenum alloy, chromium (Cr), titanium (Ti) or tantalum (Ta). However, the control electrode 124 may have a multi-layered structure including two conductive layers (not shown) having different physical properties. One of the two conductive layers may be made of a metal having a low resistivity, for example, an aluminum-based metal, a silver-based metal and a copper-based metal, in order to reduce signal delay or voltage drop. The other conductive layer may be made of a material that is capable of good physical, chemical and electrical contact with other materials, particularly to ITO (indium tin oxide) and IZO (indium zinc oxide), such as a molybdenum-based metal, chromium, titanium and tantalum. A combination of a lower chromium layer and an upper aluminum (alloy) layer or a combination of a lower aluminum (alloy) layer and an upper molybdenum (alloy) layer are examples of the combination. However, the control electrode 124 may be made of various metals and conductive materials. The control electrode 124 include side surfaces slanted with respect to a surface of the substrate 110, and the slant angle is in a range of about 30° to about 80°.

An insulating film 140 made of a silicon nitride SiNₓ or the like is formed on the control electrode 124.

Semiconductors 154 made of a hydrogenated amorphous silicon (abbreviated to a-Si) or polysilicon are formed on the insulating film 140.

A pair of ohmic contacts 163 and 165 made of a silicide or an n+ hydrogenated amorphous silicon or the like that are doped with n-type impurities are formed above the semiconductors 154.

Side surfaces of the semiconductors 154 and the ohmic contacts 163 and 165 are also slanted with respect to the surface of the substrate 110, and the slant angle is in a range of about 30° to about 80°.

An input electrode 173 and an output electrode 175 are formed on the ohmic contacts 163 and 165, respectively, and the insulating film 140. In one embodiment, the input electrode 173 and the output electrode 175 are made of chromium, a molybdenum-based metal, or a refractory metal such as tantalum and titanium. The input electrode 173 and the output electrode 175 may have a multi-layered structure, which is constructed with a lower layer (not shown) made of the refractory metal and an upper layer (not shown) made of a low resistance material disposed thereon. A two-layered structure of a lower chromium or molybdenum (alloy) layer and an upper aluminum layer, and a three-layered structure of a lower molybdenum (alloy) layer, an intermediate aluminum (alloy) layer, and an upper molybdenum (alloy) layer are examples of the multi-layered structure. Similar to the input electrode 124 and the like, side surfaces of the input electrode 173 and the output electrode 175 are also slanted at an angle of about 30° to about 80°.

The input electrode 173 and the output electrode 175 are separated from each other and disposed at the respective sides of the control electrode 124. The control electrode 124, the input electrode 173 and the output electrode 175 together with semiconductors 154 constitute the driving transistor Qd. A channel of the driving transistor Qd is formed in the semiconductor 154 between the input electrode 173 and the output electrode 175.

The ohmic contacts 163 and 165 are interposed between the underlying semiconductors 154 and the overlying input and output electrodes 173 and 175 and have a function of reducing contact resistance. The semiconductors 154 have an exposed portion between the input electrode 173 and the output electrode 175.

A protective film (passivation layer) 180 is formed on the input electrode 173, the output electrode 175, the exposed portion of the semiconductor 154, and the insulating film 140. The protective film 180 is made of an inorganic material such as a silicon nitride and a silicon oxide, an organic material or a low dielectric-constant insulating material. In one embodiment, the dielectric constant of the lower dielectric-constant insulating material is 0.4 or less. Examples of the low dielectric-constant insulating material include a-Si:C:O and a-Si:O:F formed with a plasma enhanced chemical vapor deposition (“PECVD”). Alternatively, the protective film 180 may be made of an organic material having photosensitivity, and a surface of the protective film 180 may be planarized. In addition, in order to use excellent properties of an organic film and protect the exposed portion of the semiconductor 154, the protective film 180 may have a two-layered structure of a lower inorganic film and an upper organic film. In the protective film 180, a contact hole 185 that exposes the output electrode 175 is formed.

A pixel electrode 190 is formed on the protective film 180. The pixel electrode 190 is physically and electrically connected through the contact hole 185 to the output electrode 175. The pixel electrode is made of a transparent conductive material such as ITO and IZO or a metal having excellent reflectance such as aluminum or a silver alloy.

In addition, partition walls 361 are formed on the protective film 180. The partition walls 361 surround the pixel electrode 190 like a bank to define an opening, and are made of an organic insulating material or an inorganic insulating material.

An organic light emitting element 370 is formed on the pixel electrode 190, and the partition walls 361 enclose the organic light emitting element 370.

As shown in FIG. 4, the organic light emitting element 370 has a multi-layered structure including a light emitting layer or emitting light layer (“EML”) and auxiliary layers for improving light emitting efficiency of the light emitting layer. The auxiliary layers include an electron transport layer (“ETL”) and a hole transport layer (“HTL”) that balance electrons and holes, and an electron injecting layer (“EIL”) and an hole injecting layer (“HIL”) that enhance injection of the electrons and the holes. The auxiliary layers may be omitted.

A common electrode 270 that is applied with a common voltage is formed on the partition walls 361 and the organic light emitting element 370. The common electrode 270 is made of a reflective metal such as calcium (Ca), barium (Ba), and aluminum (Al) or a transparent conductive material, such as ITO and IZO.

An opaque pixel electrode 190 and a transparent common electrode 270 are employed in a top emission type of organic light emitting display device where an image is displayed in the upward direction of the display panel 300. A transparent pixel electrode 190 and an opaque common electrode 270 are employed in a bottom emission type of organic light emitting display device where an image is displayed in the downward direction of the display panel 300.

The pixel electrode 190, the organic light emitting element 370 and the common electrode 270 constitute the organic light emitting diode LD shown in FIG. 2. Here, the pixel electrode 190 and the common electrode 270 become the anode and the cathode, respectively. Otherwise, the pixel electrode 190 and the common electrode 270 become the cathode and the anode, respectively. The organic light emitting diode LD emits light of one of three colors according to a material of the organic light emitting element 370. An example of the three colors includes colors such as red (R), green (G) and blue (B), and may also be three primary colors. A desired color can be obtained by a spatial combination of the primary colors.

Returning to FIG. 1, the scan driver 400 is connected to the scan signal lines G₁ to Gₙ of the display panel 300 to apply the scan signals Vg₁ to Vgₙ constructed with a combination of high and low voltages Von and Voff, respectively, that turn the switching transistor Qs to the scan signal lines G₁ to Gₙ on and off, respectively.

The data driver 500 is connected to the data lines D₁ to Dₘ of the display panel 300 to apply the data voltage Vdat representing the image signal to the data lines D₁ to Dₘ. The data voltage includes normal data voltages Vdat for displaying the image and reverse bias voltages Vneg for removing stress exerted on the driving transistor Qd.

The scan driver 400 or the data driver 500 may be directly mounted in a form of at least one driving IC chip on the display panel 300. Alternatively, the scan driver 400 or the data driver 500 may be attached in a form of a tape carrier package (“TCP”) or a flexible printed circuit (“FPC”) film (not shown) in the display panel 300. The scan driver 400 or the data driver 500 may also be integrated into the display panel 300.

The signal controller 600 controls operations of the scan driver 400, the data driver 500, and the like.

The signal controller 600 receives input image signals R, G and B and input control signals for controlling display thereof from an external graphics controller (not shown). The input control signals received include, for example, a vertical synchronization signal Vsync, a horizontal synchronization signal Hsync, a main clock signal MCLK and a data enable signal DE. The signal controller 600 processes the image signals R, G and B according to an operating condition of the display panel assembly 300 based on the input control signals and the input image signals R, G and B to generate a scan control signal CONT1, a data control signal CONT2, and the like, and then transmits the generated scan control signal CONT1 to the scan driver 400 and the generated data control signal CONT2 and the processed image signal DAT to the data driver 500.

The scan control signal CONT1 includes a vertical synchronization start signal STV for indicating scan start of the high voltage Von, at least one clock signal for controlling an output of the high voltage Von, and the like. The scan control signal CONT1 may include an output enable signal OE for defining a duration time of the high voltage Von.

The data control signal CONT2 includes a horizontal synchronization start signal STH for indicating data transmission for one pixel row, a load signal LOAD for commanding application of the associated data voltages to the data lines D₁ to Dₘ, a selection signal SEL for selecting one of a normal data voltage Vdat and a reverse bias voltage as an output signal, a data clock signal HCLK, and the like.

Now, the data driver 500 will be described in detail with reference to FIGS. 5 to 7B.

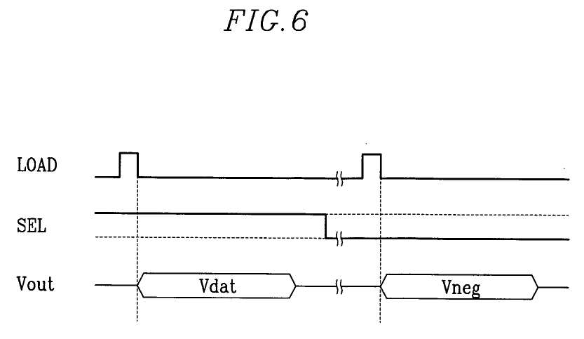

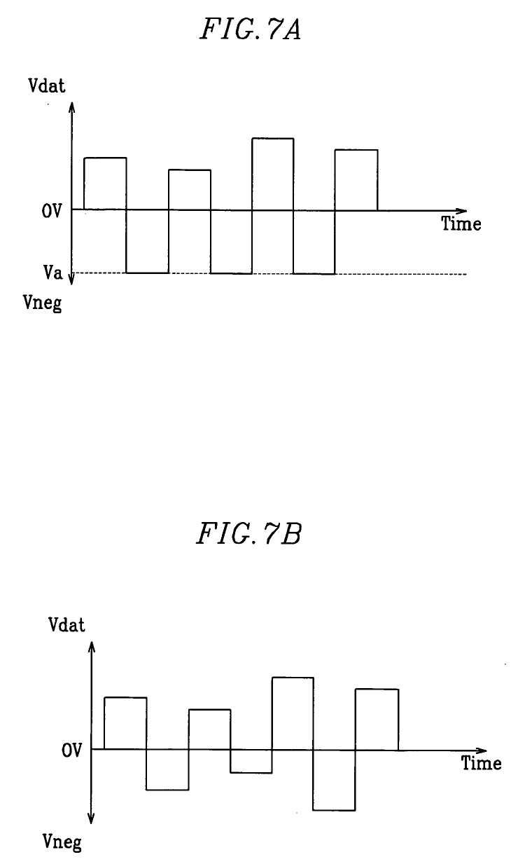

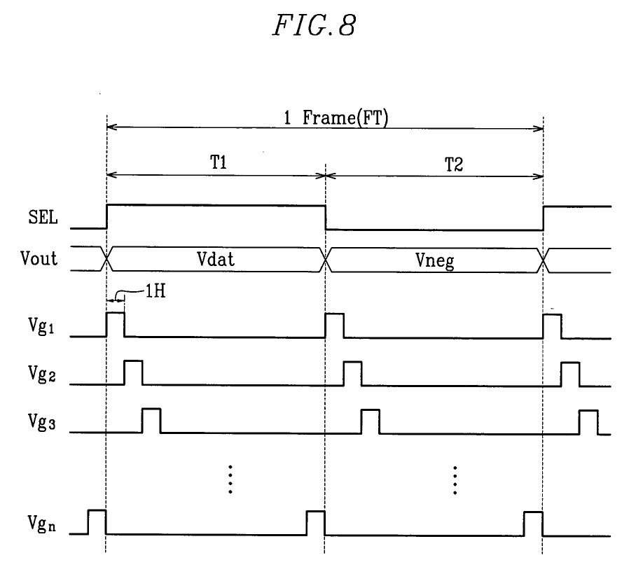

FIG. 5 is a block diagram showing an example of a data driver of the organic light emitting display device shown in FIG. 1. FIG. 6 is a timing diagram showing an example of input and output signals of the data driver shown in FIG. 5. FIGS. 7A and 7B are views of waveforms showing an example of a data voltage applied by the data driver shown in FIG. 5.

The data driver 500 includes at least one data driving IC 540. As shown in FIG. 5, the data driving IC 540 is constructed by sequentially connecting a shift register 541, a latch 543, a digital-to-analog converter 545 and a buffer 547.

When receiving the horizontal synchronization start signal STH (or a shift clock signal), the shift register 541 sequentially shifts the input image data DAT according to the data clock signal HCLK and transmits the input image data DAT to the latch 543. In a case where the data driver 500 includes a plurality of the data driving ICs 540, the shift register 541 shifts all of the image data DAT corresponding to the shift register 541 and, after that, transmits the shift clock signal to a shift register of the adjacent data driving IC.

The latch 543 stores the image data DAT sequentially input for a predetermined time period and transmits the input image data DAT to the digital-to-analog converter 545 according to a load signal LOAD.

The digital-to-analog converter 545 receives the input image data DAT and the selection signal SEL and converts the digital input image data DAT to an analog data voltage Vout according to the selection signal SEL. The digital-to-analog converter 545 transmits the analog data voltage Vout to the buffer 547. As described above, the data voltage Vout includes the normal data voltage Vdat and the reverse bias voltage Vneg, the reverse bias voltage Vneg having a polarity opposite to that of the normal data voltage Vdat. Namely, if the normal data voltage Vdat has a positive value, the reverse bias voltage Vneg has a negative value.

The buffer 547 outputs the data voltage Vout from the digital-to-analog converter 545 through the output ports Y₁ to Yᵣ and sustains the output for one horizontal period (or 1H), that is, a half of one period of the horizontal synchronization signal Hsync and the data enable signal DE. The output ports Y₁ to Yᵣ are connected to the data lines D₁ to Dₘ.

Referring to FIG. 6, the data driving IC 540 outputs the data voltage Vout in synchronization with the falling edge of the load signal LOAD. The data driving IC 540 selects one of the normal data voltage Vdat and the reverse bias voltage Vneg according to the selection signal SEL, and outputs the selected voltage. More specifically, when the selection signal SEL has a high level, the data driving IC 540 outputs the normal data voltage Vdat through the output ports Y₁ to Yᵣ. When the selection signal SEL has a low level, the data driving IC 540 outputs the reverse bias voltage Vneg through the output ports Y₁ to Yᵣ. Alternatively, when the selection signal SEL has a high level, the data driving IC 540 may output the reverse bias voltage Vneg through the output ports Y₁ to Yᵣ, and when the selection signal SEL has a low level, the data driving IC 540 may output the normal data voltage Vdat through the output ports Y₁ to Yᵣ.

As shown in FIG. 7A, the reverse bias voltage Vneg may have a constant value Va. For example, the constant value Va may be set to a value ranging from about −20V to about −4V. In addition, the absolute value of the constant Va may be larger that a maximum value of the normal data voltage Vdat. Alternatively, the absolute value of the constant Va may be about an average value of the normal data voltage Vdat. On the other hand, as shown in FIG. 7B, the size of the reverse bias voltage Vneg may be proportional to that of the normal data voltage Vdat, which is applied (or is to be applied) to the driving transistor Qd. The ratio of the magnitudes of the reverse and normal data voltages Vneg and Vdat may be set to a range of from about 50% to about 200%. The reverse bias voltage Vneg may be set according to design factors such as a range of the normal data voltage Vdat, or a type or characteristics of the organic light emitting diode LD.

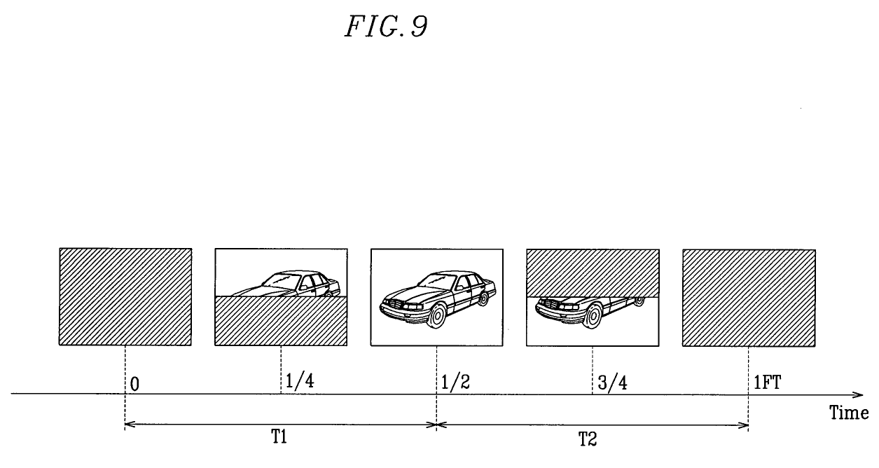

Now, the operations of the organic light emitting display device will be described in detail with reference to FIGS. 8 and 9.

FIG. 8 is a timing diagram showing an example of an exemplary embodiment of a driving signal of the organic light emitting display device according to the present invention. FIG. 9 is a schematic view showing a screen of the organic light emitting display device on which an image is displayed according to the driving signal shown in FIG. 8.

Referring to FIG. 8 first, the signal controller 600 divides one frame into two time intervals T1 and T2 in order to display an image. The signal controller 600 sets the selection signal SEL to the high and low levels in the time intervals T1 and T2, respectively. The one period of the selection signal SEL becomes one frame 1 FT.

When sequentially receiving the image data DAT for one row of pixels according to the control signal CONT2 from the signal controller 600 in the time interval T1, the data driver 500 converts the image data DAT into the normal data voltages Vdat and applies the normal data voltages to the data lines D₁ to Dₘ.

The scan driver 400 applies the scan signals Vg₁ to Vgₙ to the scan signal lines G₁ to Gₙ according to the control signal CONT1 from the signal controller 600 to turn on the switching transistors Qs connected to the scan signal lines G₁ to Gₙ. As a result, the normal data voltages Vdat are applied to the control ports of the driving transistors Qd through the turned-on switching transistors Qs.

The capacitor Cst is charged with the normal data voltage Vdat applied to the driving transistor Qd, and thus, even though the switching transistor Qs turns off, the charged voltage is sustained. When the normal data voltage Vdat is applied, the driving transistor Qd turns on to output the current I_{LD} depending on the data voltage Vdat. The current I_{LD} flows through the organic light emitting diode LD displaying an image on the associated pixel PX.

After the one horizontal period 1H, the data and scan drivers 500 and 400 repeat the same operations for the next row of pixels. In this manner, the scan signals Vg₁ to Vgₙ are sequentially applied to all of the scan signal lines G₁ to Gₙ in the time interval T1, so that the normal data voltages Vdat are applied to all of the pixels PX.

When the normal data voltages Vdat are applied to all of the pixels, the time interval T2 where the selection signal SEL has the low level starts. When sequentially receiving the image data DAT for one row of pixels, the data driver 500 converts the image data DAT into the reverse bias voltage Vneg and applies the reverse bias voltage Vneg to the data lines D₁ to Dₘ. The image data DAT in the time interval T2 have values equal or proportional to those of the image data DAT in the time interval T1 if needed. Otherwise, the image data DAT in the time interval T2 may have predetermined values irrespective of the image data DAT in the time interval T1.

The scan driver 400 applies the scan signals Vg₁ to Vgₙ to the scan signal lines G₁ to Gₙ to turn on the switching transistors Qs connected to the scan signal lines G₁ to Gₙ. As a result, the reverse bias voltages Vneg applied to the data lines D₁ to Dₘ are applied to the control ports of the driving transistors Qd through the turned-on switching transistors Qd.

The capacitor Cst is charged with the reverse bias voltage Vneg applied to the driving transistor Qd, and thus, even though the switching transistor Qs turns off, the charged voltage is sustained. When the reverse bias voltage Vneg is applied, the driving transistor Qd turns off. Therefore, no current flows through the organic light emitting diode D, such that the organic light emitting diode D does not emit light. As a result, black is displayed on the screen of the organic light emitting display device.

After the one horizontal period 1H, the data driver 500 and the scan driver repeat the same operations for the next row of pixels. In this manner, the scan signals Vg₁ to Vgₙ are sequentially applied to all of the scan signal lines G₁ to Gₙ in the rear half frame, that is, the time interval T2, so that the reverse bias voltages Vneg are applied to all of the pixels PX.

When the reverse bias voltages Vneg are applied to all of the pixels PX, the time interval T2 ends. The next fame then starts, and the same operations are repeated.

In this way, if the reverse bias voltage Vneg is applied to the control port of the driving transistor Qd, the transition of the threshold voltage of the driving transistor Qd can be prevented. Namely, as described above, if a DC voltage is applied to the control port of the driving transistor Qd for a long time period, the threshold voltage of the driving transistor Qd is transitioned as time passes, so that the image quality deteriorates. However, in the exemplary embodiments described herein, the reverse bias voltages Vneg is applied to remove the stress of the driving transistor Qd caused by the positive normal data voltage Vdat for displaying the image, so that the transition of the threshold voltage of the driving transistor can be prevented.

In the exemplary embodiment of the organic light emitting display device, one frame is divided into two time intervals T1 and T2, and each of the time intervals T1 and T2 are scanned with all of the scan signals Vg₁ to Vgₙ, so that a substantial frame frequency is twice a frame frequency of the input image signals R, G and B.

The signal controller 600 may include a memory (not shown) for storing the image data DAT in order to display the image for two time intervals T1 and T2 divided from one frame.

Referring to FIG. 9, black is displayed on the entire screen at the initial time of the frame according to the reverse bias voltage Vneg of the previous frame. When the time interval T1 starts, the image is sequentially displayed from the top portion of the screen downwardly. At ¼ frame, the image is displayed on an upper half of the screen. When the time interval T1 ends (½ frame), the image is displayed on the entire screen. Next, when the time interval T2 starts, black is sequentially displayed from the top portion of the screen downwardly. At ¾ frame, black is displayed on the upper half of the screen. When the time interval T2 ends (1 frame), black is displayed on the entire screen.

From the time that the normal data voltage Vdat is applied in the time interval T1 to the time that the reverse bias voltage Vneg is applied in the time interval T2, each of the pixels PX emits light. From the time that the reverse bias voltage Vneg is applied in the time interval T2 to the time that the normal data voltage Vdat is applied in the time interval T1 of the next frame, each of the pixels PX does not emit light. In this way, each of the pixels PX emits light in half of the frame, but each of the pixels PX does not emit light in the remaining half of the frame. Therefore, an impulse driving effect can be obtained. As a result, it is possible to prevent an unclear image or a blurring phenomenon from occurring on the screen.

On the other hand, a multiple of one horizontal period 1H may be used as a period of the selection signal SEL. In this case, one frame is divided into two time intervals T1 and T2, and the selection signals SEL for the time intervals T1 and T2 has a phase difference of 180°. As an example, if the period of the selection signal SEL is 2H, the level of the selection signal SEL changes every 1H. Therefore, the normal data voltage Vdat and the reverse bias voltage Vneg are alternately applied to every row of pixels, so that the image and black are alternately displayed every row of pixels. As another example, if the period of the selection signal SEL is 4H, the level of the selection signal SEL changes every 2H. Therefore, the normal data voltage Vdat and the reverse bias voltage Vneg are alternately applied to every two rows of pixels, so that the image and black are alternately displayed every two rows of pixels. Accordingly, the number of rows of pixels where the image and black are displayed changes according to the period of the selection signal SEL.

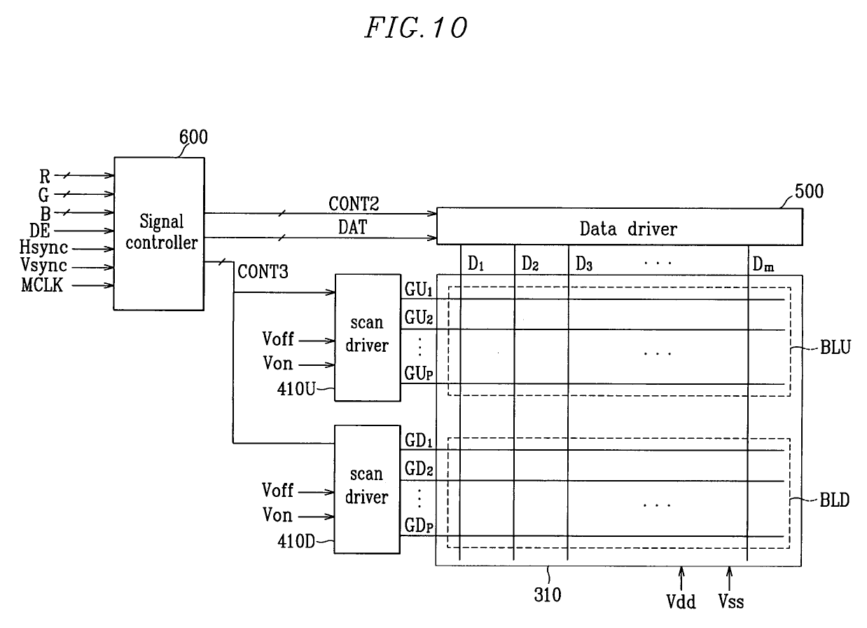

Now, another exemplary embodiment of an organic light emitting display device according to the present invention will be descried in detail with reference to FIG. 10.

FIG. 10 is a block diagram showing another exemplary embodiment of an organic light emitting display device according to the present invention.

As shown in FIG. 10, the exemplary embodiment of the organic light emitting display device includes a display panel 310, scan drivers 410U and 410D, and a data driver 500 that are connected to the display panel 310, and a signal controller 600 that controls the drivers 410U, 410 D and 500.

The display panel 310 is divided into two blocks BLU and BLD. As seen in the block diagram, the display panel 300 has a plurality of scan lines GU₁ to GUₚ and GD₁ to GDₚ, a plurality of data lines D₁ to Dₘ, and a plurality of pixels PX that are connected to the lines and arrayed substantially in a matrix.

The scan signal lines GU₁ to GUₚ and GD₁ to GDₚ are disposed on the upper and lower blocks BLU and BLD, respectively, to transmit scan signals VU₁ to VUₚ and VD₁ to VDₚ, respectively. The scan signal lines GU₁ to GUₚ and GD₁ to GDₚ extend substantially in the row direction and are separated by a predetermined interval and are substantially parallel to each other.

The data lines D₁ to Dₘ, which transmit data voltages Vout, pass through the upper and lower blocks BLU and BLD and extend substantially in the column direction and are separated from and substantially parallel to each other.

Other components of the display panel 310 are the same as those of the display panel 300 shown in FIG. 1. In addition, a pixel structure of the display panel 310 is substantially the same as that of the pixel shown in FIG. 2 for the display panel 300 of FIG. 1.

The scan drivers 410U and 410D are connected to the scan signal lines GU₁ to GUₚ and GD₁ to GDₚ, respectively, to apply the scan signals VU₁ to VUₚ and VD₁ to VDₚ, respectively, constructed as a combination of a high voltage Von and a low voltage Voff to the scan signal lines GU₁ to GUₚ and GD₁ to GDₚ according to a scan control signal CONT3 from the signal controller 600.

The data driver 500 and the signal controller 600 are substantially the same as those shown in FIGS. 1 and 5. As described above, most features of the organic light emitting display device shown in FIGS. 1 to 7B may be employed by the organic light emitting display device shown in FIG. 10.

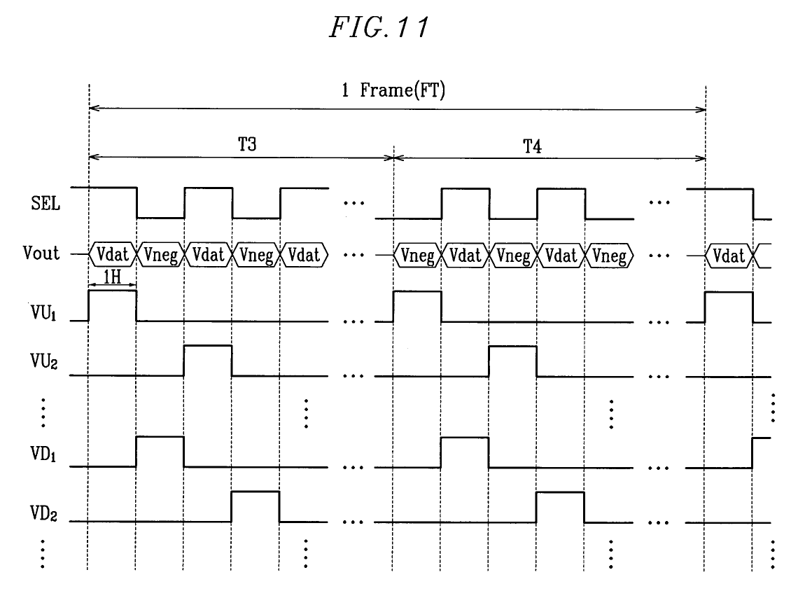

Now, the operations of the organic light emitting display device will be described in detail with reference to FIGS. 11 through 13.

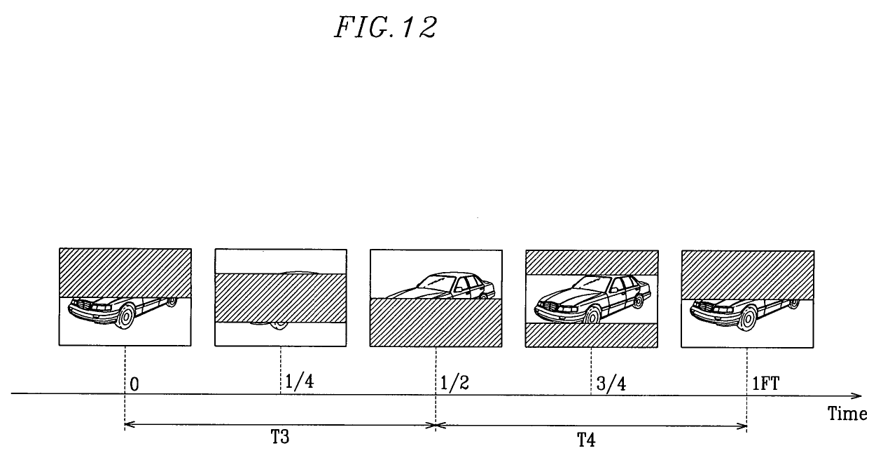

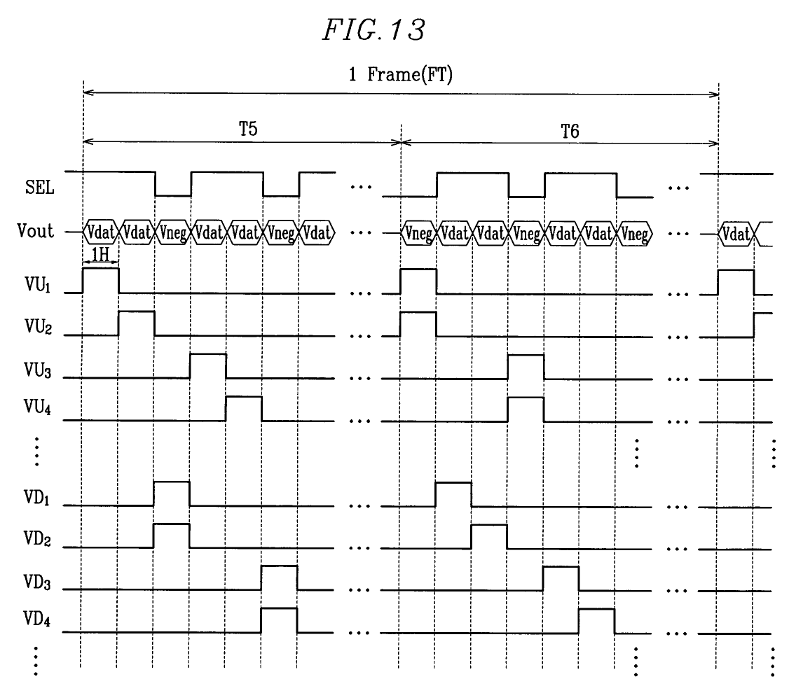

FIG. 11 is a timing diagram showing an example of another exemplary embodiment of a driving signal of the organic light emitting display device according to the present invention. FIG. 12 is a schematic view showing a screen of the organic light emitting display device on which an image is displayed according to the driving signal shown in FIG. 11. FIG. 13 is a timing diagram showing an example of yet another exemplary embodiment of a driving signal of the organic light emitting display device according to the present invention.

Referring to FIG. 11, the signal controller 600 divides one frame into two time intervals T3 and T4 to display an image. The signal controller 600 sets a period of each selection signal SEL in the two time intervals T3 and T4 to 2H and set a phase difference between the selection signals SEL in the two time intervals T3 and T4 to 180°. Accordingly, the selection signal SEL has a high level when the time interval T3 starts, and the selection signal SEL has a low level when the time interval T4 starts. In addition, the level of the selection signal SEL changes every 1H.

When the selection signal SEL has the high level in the time interval T3, the data driver 500 applies the normal data voltages Vdat to the data lines D₁ to Dₘ, and the scan driver 410U applies the scan signals VU₁ to VUₚ to the scan signal lines GU₁ to GUₚ.

When the selection signal SEL has the low level in the time interval T3, the data driver 500 applies the reverse bias voltages Vneg to the data lines D₁ to Dₘ, and the scan driver 410D applies the scan signals VD₁ to VDₚ to the scan signal lines GD₁ to GDₚ.

Therefore, the scan signals VU₁ to VUₚ and VD₁ to VDₚ are alternately applied in units of 1H, so that the normal data voltages Vdat and the reverse bias voltages Vneg are alternately applied to the upper block BLU and the lower block BLD, respectively. Accordingly, the image is sequentially displayed on the upper block BLU, and black is sequentially displayed on the lower block BLD.

On the contrary, when the selection signal SEL has the low level in the time interval T4, the data driver 500 applies the reverse bias voltages Vneg to the data lines D₁ to Dₘ, and the scan driver 410U applies the scan signals VU₁ to VUₚ to the scan signal lines GU₁ to GUₚ.

When the selection signal SEL has the high level in the time interval T4, the data driver 500 applies the normal data voltages Vdat to the data lines D₁ to Dₘ, and the scan driver 410D applies the scan signals VD₁ to VDₚ to the scan signal lines GD₁ to GDₚ.

Therefore, the scan signals VU₁ to VUₚ and VD₁ to VDₚ are alternately applied in units of 1H, so that the reverse bias voltages Vneg and the normal data voltages Vdat are alternately applied to the upper block BLU and the lower block BLD, respectively. Accordingly, black is sequentially displayed on the upper block BLU, and the image is sequentially displayed on the lower block BLD.

Referring to FIG. 12, at the beginning of the frame, black is displayed on the upper half of the screen due to the reverse bias voltages Vneg of the previous frame, and an image corresponding to the normal data voltages Vdat of the previous frame is displayed on the lower half of the screen. When the time interval T3 starts, the image is sequentially displayed from the top portion of the upper half of the screen, and black is sequentially displayed from the top portion of the lower half of the screen. At ¼ frame, the image is displayed down to the center of the upper half of the screen, and black is displayed down to the center of the lower half of the screen. When the time interval T3 ends (½ frame), the image is displayed on the upper half of the screen, and black is displayed on the lower half of the screen. Next, when the time interval T4 starts, black is sequentially displayed from the top portion of the upper half of the screen, and the image is sequentially displayed from the top portion of the lower half of the screen. At ¾ frame, black is displayed down to the center of the upper half of the screen, and the image is displayed down to the center of the lower half of the screen. When the time interval T4 ends, black is displayed on the upper half of the screen, and the image is displayed on the lower half of the screen.

On the other hand, the image and black may be displayed in various manners by setting the period of the selection signal SEL to 2H or more and adjusting the order of applying the scan signals VU₁ to VUₚ and VD₁ to VDₚ to the scan signal lines GU₁ to GUₚ and GD₁ to GDₚ.

Referring to FIG. 13, the signal controller 600 divides one frame into two time intervals T5 and T6 to display an image. The period of the selection signal SEL in each of the time intervals T5 and T6 is 3H, and a duty ratio thereof is 66.7%. Therefore, the selection signal SEL has the high level for 2H of one period, and the selection signal SEL has the low level for 1H of one period. The selection signal SEL has the high level when the time interval T5 starts, and the selection signal SEL has the low level when the time interval T6 starts.

When the selection signal SEL has the high level in the time interval T5, the data driver 500 applies the normal data voltages Vdat to the data lines D₁ to Dₘ, and the scan driver 410U sequentially applies two of the scan signals VU₁ to VUₚ to two of the scan signal lines GU₁ to GUₚ of the upper block BLU for 2H in units of 1H.

When the selection signal SEL has the low level in the time interval T5, the data driver 500 applies the reverse bias voltages Vneg to the data lines D₁ to Dₘ, and the scan driver 410D applies two of the scan signals VD₁ to VDₚ to two of the scan signal lines GD₁ to GDₚ of the lower block BLD for 1H.

When the selection signal SEL has the low level in the time interval T6, the data driver 500 applies the reverse bias voltages Vneg to the data lines D₁ to Dₘ, and the scan driver 410U applies two of the scan signals VU₁ to VUₚ to two of the scan signal lines GU₁ to GUₚ of the upper block BLU for 1H.

When the selection signal SEL has the high level in the time interval T6, the data driver 500 applies the normal data voltages Vdat to the data lines D₁ to Dₘ, and the scan driver 410D sequentially applies two of the scan signals VD₁ to VDₚ to two of the scan signal lines GD₁ to GDₚ of the lower block BLU for 2H in units of 1H.

In this way, black is displayed by simultaneously applying the scan signals to a plurality of the scan signal lines, so that it is possible to prolong the length of each scan signal and obtain a driving margin for a high resolution organic light emitting display device.

As another example, an image and black may be displayed alternately every three pixel rows by setting the period of the selection signal SEL to 4H and the duty ratio thereof to 75%. In this example, the image is sequentially displayed on three pixel rows in units of one pixel row, and black is simultaneously displayed on three pixel rows. Alternatively, the image and black may be displayed by setting the period of the selection signal SEL to 4H or more and adjusting the duty ratio thereof appropriately.

Most of the aforementioned features of the operations of the organic light emitting display device shown in FIGS. 8 and 9 may be employed by the organic light emitting display device shown in FIGS. 11 to 13.

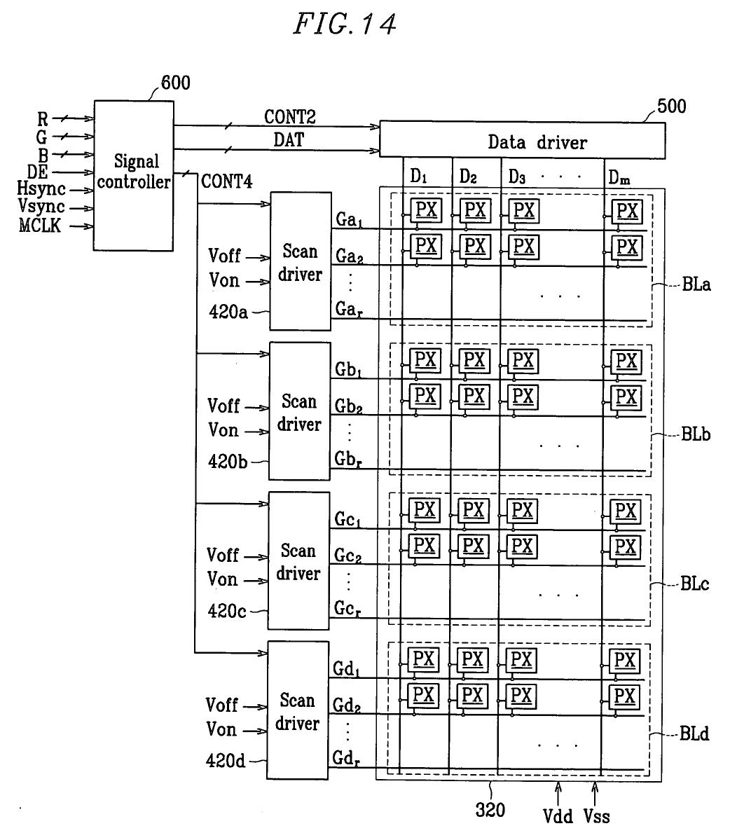

Now, another exemplary embodiment of an organic light emitting display device according to the present invention will be descried in detail with reference to FIG. 14.

FIG. 14 is a block diagram showing the organic light emitting display device according to another exemplary embodiment of the present invention.

As shown in FIG. 14, the exemplary embodiment of the organic light emitting display device according to the present invention includes a display panel 320, scan drivers 420a, 420b, 420c and 420d, and a data driver 500 that are connected to the display panel 320, and a signal controller 600 that controls the drivers.

The display panel 320 is divided into four blocks BLa, BLb, BLc, and BLd. As seen in the block diagram, the display panel 320 has a plurality of scan lines Ga₁ to Gaᵣ, Gb₁ to Gbᵣ, Gc₁ to Gcᵣ and Gd₁ to Gdᵣ, a plurality of data lines D₁ to Dₘ, a plurality of driving voltage lines (not shown), and a plurality of pixels PX that are connected to the lines and arrayed substantially in a matrix.

The scan signal lines Ga₁ to Gaᵣ, Gb₁ to Gbᵣ, Gc₁ to Gcᵣ and Gd₁ to Gdᵣ are disposed on the first to fourth blocks BLa, BLb, BLc and BLd, respectively, to transmit scan signals Va₁ to Vaᵣ, Vb₁ to Vbᵣ, Vc₁ to Vcᵣ and Vd₁ to Vdᵣ, respectively. The scan signal lines Ga₁ to Gaᵣ, Gb₁ to Gbᵣ, Gc₁ to Gcᵣ and Gd₁ to Gdᵣ extend substantially in the row direction and are separated by a predetermined interval and are substantially parallel to each other.

The data lines D₁ to Dₘ that transmit data voltages Vout pass through the first to fourth blocks BLa, BLb, BLc and BLd and extend substantially in the column direction and are separated from and substantially parallel to each other.

Other components of the display panel 320 are the same as those of the display panel 300 shown in FIG. 1. In addition, a pixel structure of the display panel 320 is substantially the same as that of the pixel structure of the display panel 300 shown in FIG. 2.

The scan drivers 420a, 420b, 420c and 420d are connected to the scan signal lines Ga₁ to Gaᵣ, Gb₁ to Gbᵣ, Gc₁ to Gcᵣ and Gd₁ to Gdᵣ, respectively, to apply the scan signals Va₁ to Vaᵣ, Vb₁ to Vbᵣ, Vc₁ to Vcᵣ and Vd₁ to Vdᵣ constructed as a combination of a high voltage Von and a low voltage Voff to the scan signal lines Ga₁ to Gaᵣ, Gb₁ to Gbᵣ, Gc₁ to Gcᵣ and Gd₁ to Gdᵣ according to a scan control signal CONT4 from the signal controller 600.

The data driver 500 and the signal controller 600 are substantially the same as those shown in FIGS. 1 and 5. Most of the aforementioned features of the organic light emitting display device shown in FIGS. 1 to 7B may be employed by the organic light emitting display device shown in FIG. 14.

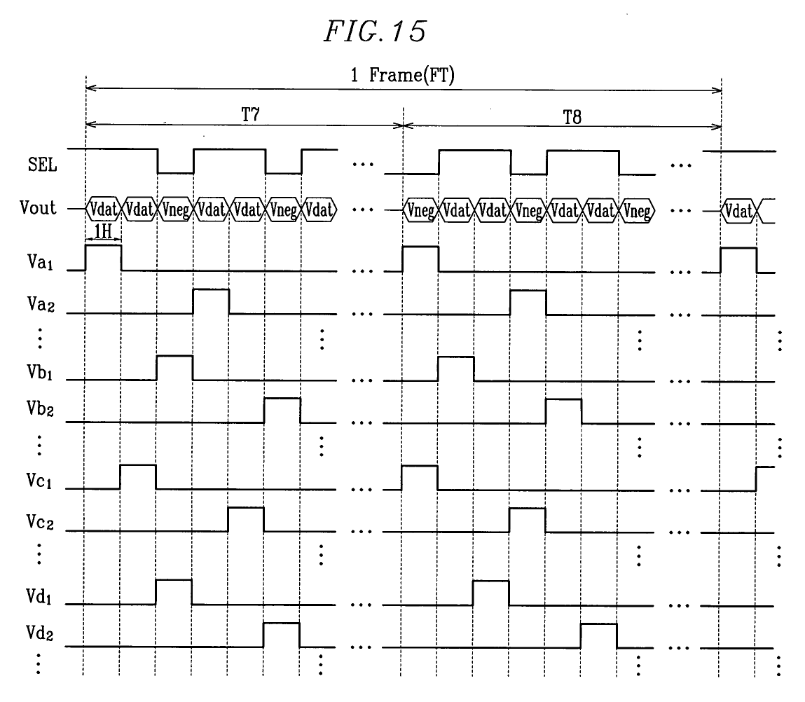

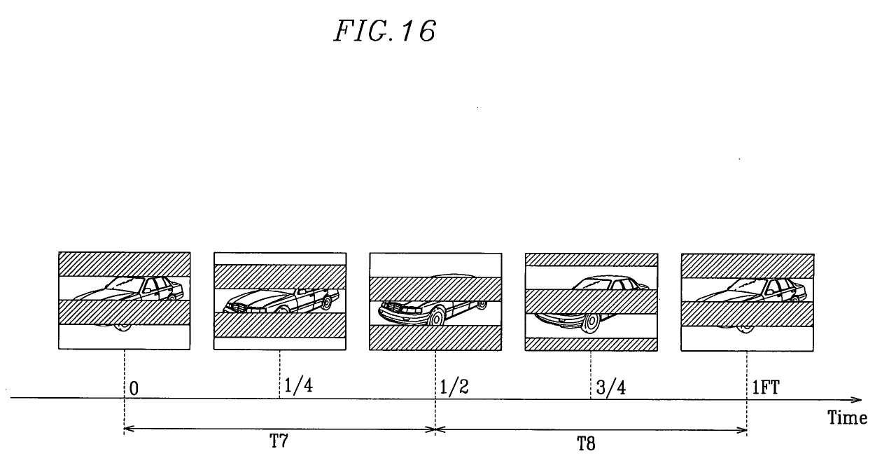

Now, the operations of the organic light emitting display device will be described in detail with reference to FIGS. 15 and 16.

FIG. 15 is a timing diagram showing an example of another exemplary embodiment of a driving signal of the organic light emitting display device according to the present invention. FIG. 16 is a schematic view showing a screen of the organic light emitting display device on which an image is displayed according to the driving signal shown in FIG. 15.

Referring to FIG. 15, the signal controller 600 divides one frame into two time intervals T7 and T8 to display an image. The period of the selection signal SEL in each of the time intervals T7 and T8 is 3H, and a duty ratio thereof is 66.7%. Therefore, the selection signal SEL has the high level for 2H of one period, and the selection signal SEL has the low level for 1H of one period. The selection signal SEL has the high level when the time interval T7 starts, and the selection signal SEL has the low level when the time interval T8 starts.

When the selection signal SEL has the high level in the time interval T7, the data driver 500 applies the normal data voltages Vdat to the data lines D₁ to Dₘ. The scan driver 420a applies the scan signals Va₁ to Vaᵣ to the scan signal lines Ga₁ to Gaᵣ of the first block BLa for a first 1H. The scan driver 420c applies the scan signals Vc₁ to Vcᵣ to the scan signal lines Gc₁ to Gcᵣ of the third block BLc for a second 1H.

When the selection signal SEL has the low level in the time interval T7, the data driver 500 applies the normal data voltages Vdat to the data lines D₁ to Dₘ. The scan drivers 420b and 420d simultaneously apply the scan signals Vb₁ to Vbᵣ and Vd₁ to Vdᵣ to the scan signal lines Gb₁ to Gbᵣ and Gd₁ to Gdᵣ of the second and fourth blocks BLb and BLd, respectively, for a third 1H.

When the selection signal SEL has the low level in the time interval T8, the data driver 500 applies the reverse bias voltages Vneg to the data lines D₁ to Dₘ. The scan drivers 420a and 420c simultaneously apply the scan signals Va₁ to Vaᵣ and Vc₁ to Vcᵣ to the scan signal lines Ga₁ to Gaᵣ and Gc₁ to Gcᵣ of the first and third blocks BLa and BLc, respectively, for 1H.

When the selection signal SEL has the high level in the time interval T8, the data driver 500 applies the normal data voltages Vdat to the data lines D₁ to Dₘ. The scan driver 420b applies the scan signals Vb₁ to Vbᵣ to the scan signal lines Gb₁ to Gbᵣ of the second block BLb for a first 1H, and the scan driver 420d applies the scan signals Vd₁ to Vdᵣ to the scan signal lines Gd₁ to Gdᵣ of the fourth block BLd for a second 1H.

Referring to FIG. 16, at the beginning of the frame, black is displayed on the first and third block BLa and BLb of the screen, and an image corresponding to the previous frame is displayed on the second and fourth blocks of the screen. When the time interval T7 starts, the image is sequentially displayed from the top portions of the first and third blocks BLa and BLc, and black is sequentially displayed from the top portions of the second and fourth blocks BLb and BLd. When the time interval T7 ends (½ frame), the image is displayed on the first and third blocks BLa and BLc, and black is displayed on the second and fourth blocks BLb and BLd. Next, when the time interval T8 starts, black is sequentially displayed from the top portions of the first and third blocks BLa and BLc, and the image is sequentially displayed from the top portions of the second and fourth blocks BLb and BLd. When the time interval T8 ends, black is displayed on the first and third blocks BLa and BLc, and the image is displayed on the second and fourth blocks BLb and BLd.

In this way, one screen is divided into four or five blocks, and an image and black are alternately displayed on each block. Therefore, two black stripes which seem to circulate and scroll are displayed on the screen on which the image of one frame is displayed.

In this exemplary embodiment, the image and black may be displayed in various manners by changing the period and duty ratio of the selection signal SEL. Accordingly, it is possible to prevent transition of a threshold voltage of a driving transistor Qd and to improve image quality.

As described above, most features of the operations of the organic light emitting display device shown in FIGS. 11 to 13 may be employed by the organic light emitting display device shown in FIGS. 15 and 16.

Alternatively, for the displaying operation, the display panel and the scan driver may be divided into three regions, and one frame may be divided into three time intervals. In this case, an image is displayed in two time intervals, and black is displayed in the remaining one time interval. In addition, for the displaying operation, the display panel and the scan driver may be divided into five or more regions, and one frame may be divided into five or more time intervals. In this case, the time intervals may be controlled similar to the above-described manners.

According to the present invention, separate transistors and signal lines are not added to driving transistors, data lines, and scan lines, and a data driving IC applies reverse bias voltages to pixels, so that it is possible to increase aspect ratios of the pixels and prevent transition of threshold voltages of the driving transistors. In addition, normal data voltages and reverse bias voltages are alternately applied in one frame, so that it is possible to improve image quality.

Although the exemplary embodiments and the modified examples of the present invention have been described, the present invention is not limited to the exemplary embodiments and examples, but may be modified in various forms without departing from the scope of the appended claims, the detailed description and the accompanying drawings of the present invention. Therefore, it is natural that such modifications belong to the scope of the present invention.

What is claimed is:

1. A display device comprising:
a first pixel row group and a second pixel row group, each group comprising at least one pixel row having a plurality of pixels, each pixel having a switching transistor, a capacitor, a driving transistor connected to the switching transistor, and a light emitting element connected to the driving transistor;
a plurality of scan signal lines connected to the switching transistors to transmit scan signals;
a plurality of data lines connected to the switching transistors to transmit data voltages, the data voltages comprising a normal data voltage and a reverse bias voltage; and
a data driver generating the data voltages, the data driver applying one of the normal data voltage and the reverse bias voltage to the data line according to a selection signal,
wherein the normal data voltage is applied to the driving transistors of the first pixel row group, and the reverse bias voltage is applied to the driving transistors of the second pixel row group.

2. The display device of claim 1,
wherein each of the first pixel row group and the second pixel row group comprises a plurality of pixel rows, and
wherein the normal data voltage is sequentially applied to the driving transistors of the first pixel row groups row-by-row, and
wherein the reverse bias voltage is simultaneously applied to the driving transistors of a plurality of the pixel rows of the second pixel row group.

3. The display device of claim 2,
wherein one frame is divided into a first interval and a second interval,
wherein, when the normal data voltage is applied to the driving transistors of the first pixel row group in the first interval, the reverse bias voltage is applied in the second interval, and
wherein, when the reverse bias voltage is applied to the driving transistors of the second pixel row group in the first interval, the normal data voltage is applied in the second interval.

4. The display device of claim 1,
wherein, after the normal data voltage is applied to the driving transistors of the first pixel row group, the reverse bias voltage is applied, and
wherein, after the reverse bias voltage is applied to the driving transistors of the second pixel row group, the normal data voltage is applied.

5. The display device of claim 4, wherein the first pixel row group and the second pixel row group are alternately arrayed.

6. The display device of claim 4, wherein the normal data voltage and the reverse bias voltage are alternately applied to the driving transistors row-by-row.

7. The display device of claim 4, further comprising a third pixel row group and a fourth pixel row group, each group comprising at least one pixel row,
wherein the normal data voltage is applied to the driving transistors of the third pixel row group, and the reverse bias voltage is applied to the driving transistors of the fourth pixel row group.

8. The display device of claim 7, wherein the first pixel row group, the second pixel row group, the third pixel row group and the fourth pixel row group are sequentially arrayed.

9. The display device of claim 8, wherein the reverse bias voltage is simultaneously applied to the second pixel row group and the fourth pixel row group.

10. The display device of claim 9, wherein the normal data voltage is sequentially applied to the driving transistors of the first pixel row group and the third pixel row group.

11. The display device of claim 1,
wherein the normal data voltage is sequentially applied to the driving transistors of a plurality of the pixel rows, and
wherein the reverse bias voltage is simultaneously applied to the driving transistors of a plurality of the pixel rows.

12. The display device of claim 11,
wherein one frame is divided into a first interval and a second interval,
wherein, when the normal data voltage is applied to the driving transistors in the first interval, the reverse bias voltage is applied in the second interval, and
wherein, when the reverse bias voltage is applied to the driving transistors in the first interval, the normal data voltage is applied in the second interval.

13. The display device of claim 1,
wherein the selection signal has a high level and a low level, and
wherein the data driver outputs one of the normal data voltage and the reverse bias voltage according to the level of the selection signal.

14. The display device of claim 13, wherein a period of the selection signal is a multiple of one horizontal period.

15. The display device of claim 14, wherein in one frame, a length of the interval where the data driver outputs the normal data voltage is equal to or larger than a length of the interval where the data driver outputs the reverse bias voltage.

16. The display device of claim 14, wherein in one period of the selection signal, a length of the level of the selection signal where the data driver outputs the normal data voltage is equal to or larger than a length of the level of the selection signal where the data driver outputs the reverse bias voltage.

17. The display device of claim 1, wherein a polarity of the reverse bias voltage is opposite to a polarity of the normal data voltage.

18. The display device of claim 17, wherein the reverse bias voltage is a negative voltage.

19. The display device of claim 18, wherein a size of the reverse bias voltage is proportional to a size of the normal data voltage.

20. The display device of claim 18, wherein the reverse bias voltage has a predetermined value.

21. A display device comprising:
a display panel that is divided into a plurality of blocks;
a plurality of scan signal lines disposed on the display panel to transmit scan signals;
a plurality of data lines intersecting the scan signal lines to transmit data voltages, the data voltages comprising a normal data voltage and a reverse bias voltage;
a plurality of pixels, each pixel having a switching transistor connected to the scan signal line and the data line, a capacitor, a driving transistor connected to the switching transistor, and a light emitting element connected to the driving transistor; and
a data driver generating the data voltage, the data driver applying one of the normal data voltage and the reverse bias voltage to the data line according to a selection signal,
wherein, when the reverse bias voltage is applied to the data line, the scan signals are simultaneously applied to at least two scan signal lines.

22. The display device of claim 21,
wherein one frame comprises a first interval and a second interval,
wherein, when the normal data voltage is applied to pixels in the first interval, the reverse bias voltage is applied in the second interval, and
wherein, when the reverse bias voltage is applied to the pixels in the first interval, the normal data voltage is applied in the second interval.

23. The display device of claim 22, further comprising a scan driver that applies scan signals to the scan signal lines to turn on the switching transistor of each pixel at least twice in one frame.

24. The display device of claim 21,
wherein the plurality of blocks comprise a first block and a second block,
wherein the scan signals are sequentially applied to the scan signal lines of the first block, and
wherein the scan signals are simultaneously applied to at least two scan signal lines of the second block.

25. The display device of claim 24,
wherein the normal data voltages are applied to the driving transistors of the first block, and
wherein the reverse bias voltages are applied to the driving transistors of the second block.

26. The display device of claim 21,
wherein the plurality of blocks comprise a first block, a second block, a third block and a fourth block that are sequentially arrayed,
wherein the scan signals are sequentially applied to the scan signal lines of the first block and the third block, and
wherein the scan signals are simultaneously applied to at least one scan signal line of the second block and at least one scan signal line of the fourth block.

27. The display device of claim 26,
wherein the normal data voltages are applied to the driving transistors of the first block and the third block, and
wherein the reverse bias voltages are applied to the driving transistors of the second block and the fourth block.

28. A method of driving a display device having a display panel that is divided into a plurality of blocks, a plurality of scan signal lines disposed on the display panel to transmit scan signals, a plurality of data lines transmitting data voltages comprising a normal data voltage and a reverse bias voltage, and a plurality of pixels, each pixel having a switching transistor connected to the scan signal line and the data line, a driving transistor connected to the switching transistor, and a light emitting element connected to the driving transistor, the method comprising:
applying the normal data voltage to the data lines;
applying the scan signals to the scan signal lines at the same time as or after applying the normal data voltage;
applying the reverse bias voltage to the data lines; and
simultaneously applying the scan signals to at least two of the scan signal lines at the same time as or after applying the reverse bias voltage.

29. The method of claim 28,
wherein the plurality of blocks comprise a first block and a second block,
wherein the applying the scan signals comprises applying the scan signals to the scan signal lines of the first block, and
wherein the simultaneously applying the scan signals comprises simultaneously applying the scan signals to at least two of the scan signal lines of the second block.

30. The method of claim 28,
wherein the plurality of blocks comprise a first block, a second block, a third block and a fourth block that are sequentially arrayed,
wherein applying the scan signals comprises sequentially applying the scan signals to the scan signal lines of the first block and the scan signal lines of the third block, and
wherein simultaneously applying the scan signals comprises simultaneously applying the scan signals to the scan signal lines of the second block and the scan signal lines of the fourth block.

31. The method of claim 28, further comprising:
dividing one frame into a first interval and a second interval;
applying the reverse bias voltages in the second interval when the normal data voltages are applied to the driving transistors in the first interval; and
applying the normal data voltages in the second interval when the reverse bias voltages are applied to the driving transistors in the first interval.
